(19) United States
(12) Patent Application Publication
(10) Pub. No.: US 2016/0007014 A1
(43) Pub. Date: Jan. 7, 2016

(54) EQUIDISTANT STEREO LENS SHADER

(71) Applicants: Matthew HENDERSHOT, (US); RUBICON GROUP HOLDING LIMITED, Tortola (VG)

(72) Inventor: Matthew HENDERSHOT, Tarzana, CA (US)

(21) Appl. No.: 14/775,728

(22) PCT Filed: Mar. 17, 2014
(86) PCT No.: PCT/US2014/030349

§ 371 Date: Sep. 14, 2015

Related U.S. Application Data
(60) Provisional application No. 61/798,204, filed on Mar. 15, 2013.

(51) Int. Cl. H04N 13/04; G03B 35/18; G03B 37/00

(52) U.S. Cl. CPC H04N 13/0459; G03B 37/00; G03B 35/18

(57) ABSTRACT

An equidistant stereo lens shader includes a user controlled device and an output device. The user controlled device includes one or more controllers, which are configured for orientation of a stereo field, orientation of a projection surface relative to a camera, use of converging stereo rays or parallel stereo rays, control over the zero-parallax distance for converging rays, and control over the interocular distance. The output device is configured to output left-eye images, right-eye images, or monoscopic images as equidistant fisheye projections.

### CROSS-REFERENCE TO RELATED APPLICATIONS

This application is a national stage application (under 35 USC §371) of PCT/US2014/030349, filed Mar. 17, 2014, which claims benefit of U.S. application No. 61/798,204, filed Mar. 15, 2013, the entire disclosure of which is hereby incorporated herein by reference.

### FIELD OF THE INVENTION

The present disclosure relates to equidistant stereo lens shader technology.

### BACKGROUND OF THE INVENTION

Hemispherical projection screens are widely used as a way to provide an immersive experience for a wide variety of applications. These applications include, but are not limited to aircraft and driving simulations, planetariums and theme park attractions. As projection and computer graphics technology have advanced, and the general public has been exposed to a wide range of stereoscopic (3D) entertainment in the form of feature films and video games, there has been an increased demand to incorporate stereoscopic imagery into domed or hemispherical projection environments.

Currently available hemispherical lens shaders, found commercially and in the open source world, have failed to produce a functional stereo field across a full 180 degree hemispherical projection area. Moreover, currently available solutions all require the stereo effect to be scaled down to zero, as the viewing angle approached vertical (straight up), and in the case of a front-facing dome, vertically down. Although these shaders may be suitable for their intended purpose, there is a need for improved shaders that produce an immersive experience in which the audience can look in any direction within a hemispherical dome, and fully see stereoscopic imagery. The present invention fulfills this need and provides further related advantages, as described below.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The drawings described herein are for illustrative purposes and are not intended to limit the scope of the present disclosure.

In FIGS. 1-4, horizontal lines represent the local direction of stereo divergence on the projection surface.

FIG. 1 shows a traditional stereo field arrangement.

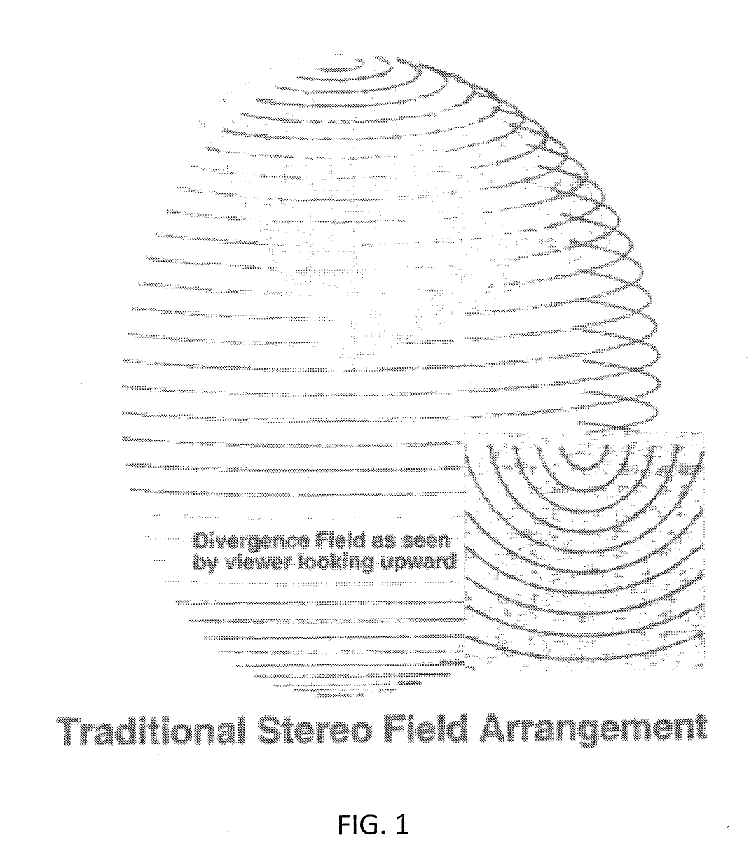

FIG. 2 shows a stereo field arrangement, according to the equidistant stereo lens shader technology described herein.

FIG. 3 shows an image plane and projected image plane.

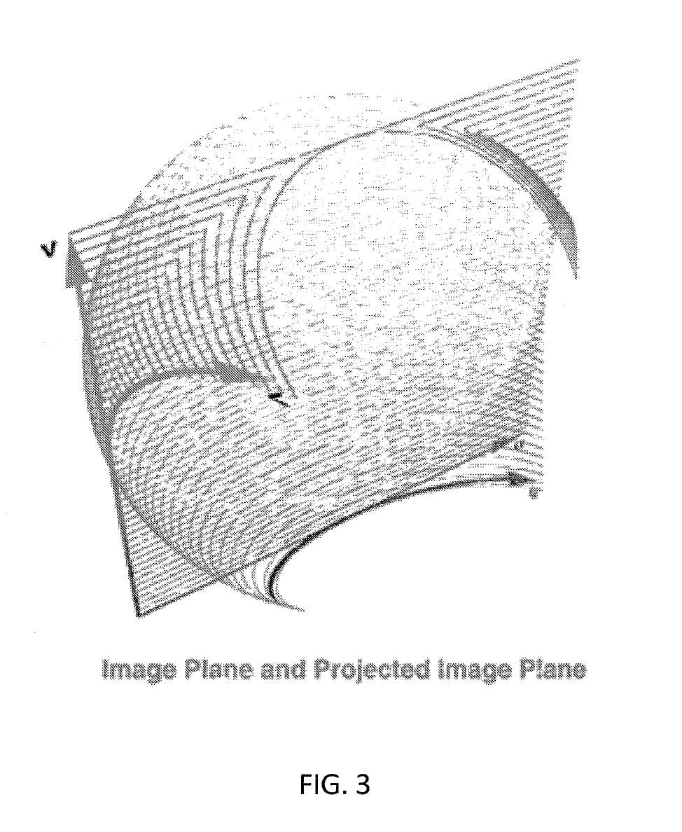

FIG. 4 shows derivative ray origins.

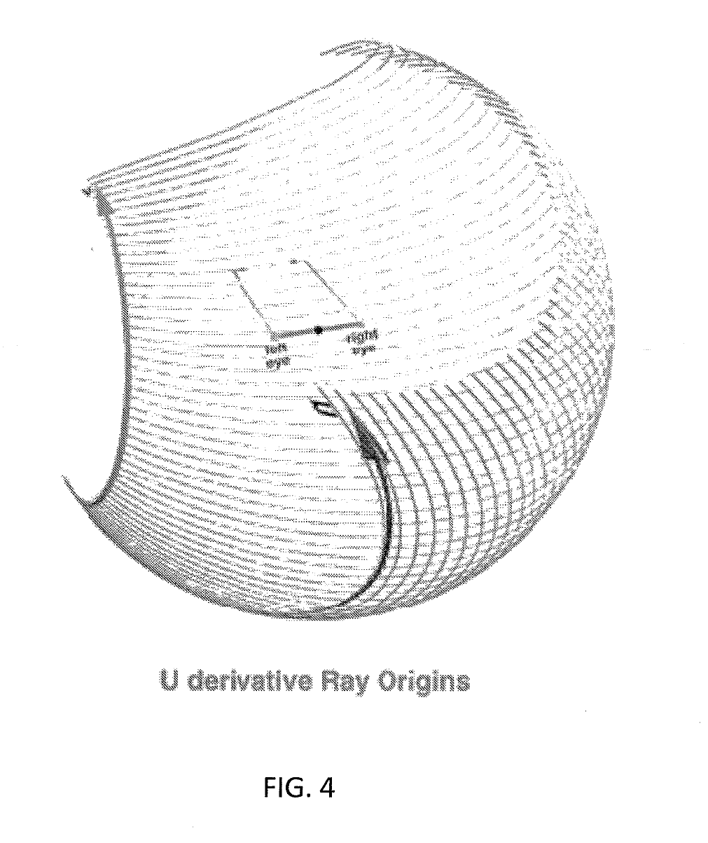

FIG. 5 is a flowchart showing steps included in an equidistant stereo lens shader process.

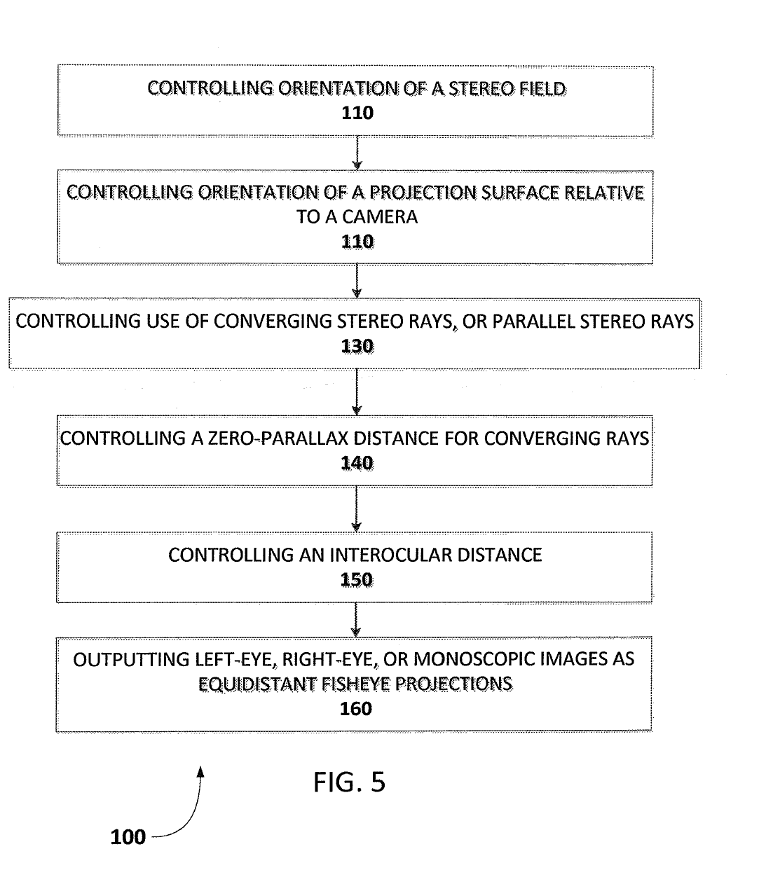

### DETAILED DESCRIPTION OF THE INVENTION

An equidistant stereo lens shader addresses the aforementioned issues by producing stereoscopic left and right images capable of representing a useful stereo field across a full 180 degree hemisphere.

In the world of computer generated imagery, images are typically computed using virtual analogies of objects and technologies found in the physical world. Three dimensional geometric objects are sculpted and painted virtually. Lights are positioned and colored virtually, and images are constructed as viewed through virtual cameras. Typically, what is “seen” through these cameras is determined by a simple perspective projection—the image plane (virtual film frame) of the camera is linearly scaled as it is projected out in the primary direction of the camera. The bounding volume created by this projection takes the form of a rectangular pyramid, or frustum, and virtual topology that is contained within that volume is what is rendered into the final image. When more sophisticated projections are required, some rendering engines allow for the construction of a lens shader.

A lens shader is coupled to a computer having computer code that instructs the rendering engine how to project a ray for each pixel of the image plane out into the virtual world. In its most basic form, a lens shader uses image coordinates for a single pixel or sample of the final image to calculate a direction in which to fire a ray. When this ray intersects a virtual object, shading, lighting and geometric information are used compute a final color for the image sample in question. In this sense, a lens shader is a direct virtual analogy for a physical camera lens, and performs the same function. However, some rendering engines also permit further variations to the behavior of the virtual camera. Of primary importance in this case is the alteration of the ray origin for each sample of the image plane.

The equidistant stereo lens shader described herein generates two images for each frame of imagery—one for the viewer's left eye, and another for their right eye. For each sample of the final image, a unique ray direction and ray origin are calculated. Effectively, each pixel of the final image has a different point of view in the virtual world. This is how the stereoscopic effect is created.

Sample vs. Pixel:

The terms “sample” and “pixel” may be used herein interchangeably. A digital image is comprised of pixels. A computer generated image may, in some instances, require the calculation of several regions within a single pixel in order to produce a better, filtered value for the final color of that pixel. These sub-pixel regions are called samples.

Stereoscopic:

The term “stereoscopic” refers to the effect of viewing a different image for the left and right eye in order to create a sense of three dimensional depth. Traditionally, this has been accomplished both physically and virtually, by employing a pair of cameras, one for the left eye image and one for the right eye image. Typically, these cameras are placed horizontally from one another, at a distance from one another which approximates the distance between a typical human's left and right eye (interocular distance).

Interocular Distance:

The term “interocular” distance is defined as the distance between the left and right acquisition point for either physical or virtual recording of stereoscopic media. Interocular Distance can also refer to the assumed distance between the ultimate viewer's left and right eyes. This distance can be adjusted to increase or decrease the stereoscopic effect, at the expense of altering scaling cues.

Stereo Divergence Field, or Stereo Field:

In the case of traditional stereoscopic media, the term is “stereo divergence field, or stereo field” is not generally used or important. This is because it is assumed that in order to create a stereoscopic effect, objects within the stereo pair of images must be offset horizontally within the left and right views by varying amounts to create the illusion of varying depth from the viewer. The horizontal direction is implied by the orientation of the viewer's eyes to one another. In the case of a viewing mechanism that surrounds the viewer, this can no longer be assumed. This is at the heart of the issue that the equidistant stereo lens shade was designed to address.

The stereo divergence field is a mathematically calculated, resolution independent field of 3-dimensional vectors which determine the direction in which image details are separated in order to achieve a stereo effect, for any possible viewing angle within a section of a spherical projection area. Therefore, for any ray that can be projected from the viewer's position onto the projection screen, which is to be spherical in shape, there is a corresponding direction that image details must be diverged to create a stereo effect. The degree of separation is a function of that image detail's intended perceived distance from the viewer, and the assumed interocular distance—or the distance between the viewer's eyes.

In the case of the equidistant stereo lens shader, the divergence in the final images is created by offsetting the ray origin from the camera's center for every sample in the left and right images. In other words, each pixel within the final image “sees” the virtual world from a slightly different position. If one were to consider looking at the horizon, the divergence direction would be horizontal. But if one were to gaze straight up, the horizontal divergence between their eyes—as projected onto a sphere—would meet the horizon at a right angle, in direct conflict with the horizontal divergence of the horizontal gaze. This is the geometric problem that the equidistant stereo lens shader solves.

Image Plane and Image Coordinates:

The term “image plane” refers to is a computer graphics conceptual construct that represents the final rendered image's bounds. Regardless of its aspect ratio, the image plane is generally assumed to have horizontal and vertical image coordinates—referred to as u and v respectively—that have bounds of 0 to 1. Therefore, any point within the image, or within a single pixel of the image, can be referred to by its floating point image coordinates. In the case of the equidistant stereo lens shader, image coordinates are the primary input that determines the output of the shader.

Ray Direction and Ray Origin:

The virtual camera, by necessity, fires rays into the virtual world in order to determine what information gets rendered into each pixel of the final output image. The direction of this camera ray will be referred to as ray direction. The beginning of that ray, which is traditionally located at the camera's position for all rays, will be referred to as the ray origin. Traditionally, a CG camera fires all of its rays from its center, and in a direction according to a simple perspective projection. The equidistant stereo lens shader lens shader determines both the direction of each ray, and where that ray begins (the ray origin).

In this document, the term “camera” will refer to a virtual CG camera. Likewise, all related terms such as image plane, angle of view, etc. refers to the virtual manifestation of these concepts within the framework of computer generated imagery.

Equidistant Projection:

Equidistant projection is the algorithm used to generate ray directions from the camera. This algorithm is analogous to an f-theta (circular fisheye) lens on a physical camera. It is a well understood mathematical projection that has been in use for decades.

The equidistant projection has the property that image coordinate distances measured from the center of the image plane have a direct linear relationship to angular measurements from the Z axis of the projection. This function and its inverse are used to generate the primary rays for the lens shader and the stereo divergence field, which itself is used to calculate the ray origins for the rendered images. The function takes image coordinates, and generates ray directions. Its inverse function takes vectors (ray directions) and generates image coordinates.

Projection:

$$x = u - 0.5$$

$$y = v - 0.5$$

$$r = \sqrt{{x}^{2} + {y}^{2}}$$

$$ϕ = \{ \begin{matrix}0 & r = 0 \\ π - a sin ( \frac{y}{r} ) & x < 0 \\ a sin ( \frac{y}{r} ) & x \geq 0\end{matrix} \\ θ = r \cdot aperture \\ vector v = \{ \begin{matrix}x = sin ( θ ) cos ( ϕ ) \\ y = sin ( θ ) sin ( ϕ ) \\ z = cos ( θ )\end{matrix}$$

Inverse Projection:

$$r = \frac{a tan 2 ( \sqrt{{x}^{2} + {y}^{2}} , - z )}{π}$$

$$ϕ = a tan 2 ( y , x )$$

$$image coordinates = \{ \begin{matrix}u = r cos ( ϕ ) + 0.5 \\ v = r sin ( ϕ ) + 0.5\end{matrix}$$

Convergence:

In traditional stereoscopic media, the concept of convergence refers to the practice of “converging” or “toeing in” the left and right cameras, such that at a predetermined distance, objects will register with themselves between the left and right images. Traditionally, this can be accomplished either by actually rotating the cameras in Y (yaw) such that their primary rays intersect at a given distance, or—preferably—offsetting their film planes horizontally to achieve the same overall effect with fewer differing perspective artifacts. This practice causes objects at the zero parallax distance to appear spacially identical in the left and right images—similar to crossing one's eyes to focus a near object. In the case of the equidistant stereo lens shader, convergence is achieved per image sample or pixel. Alternatively, the user can opt to have no convergence.

Zero-Parallax Distance:

Within the concept of convergence, the zero-parallax distance is the distance from camera at which there is no stereo divergence. Objects at the zero-parallax distance will appear the same in the left and right images. This is also sometimes referred to as focal distance. Objects will reverse their divergence direction as they pass this distance from camera.

The Equidistant Lens Shader Process

The equidistant stereo lens shader exploits an artifact of the classic equidistant projection to generate its stereo divergence field. The artifact is the shape or direction of the image plane's u-coordinate's derivative as it is projected using this function into 3 dimensions. The local directions of these vectors are suited for the generation of stereo divergence at any viewing angle within a front facing 180 degree hemisphere. There are additional features of the lens shader that allow the user to manipulate the following:

User control of the orientation of the stereo field (direction of the stereo “sweet spot”)

User control over the orientation of the projection surface relative to the camera

User controlled use of converging stereo rays, or parallel stereo rays

User control over the zero-parallax distance for converging rays

User control over the interocular distance

Output of left-eye, right-eye, or monoscopic images as equidistant fisheye projections

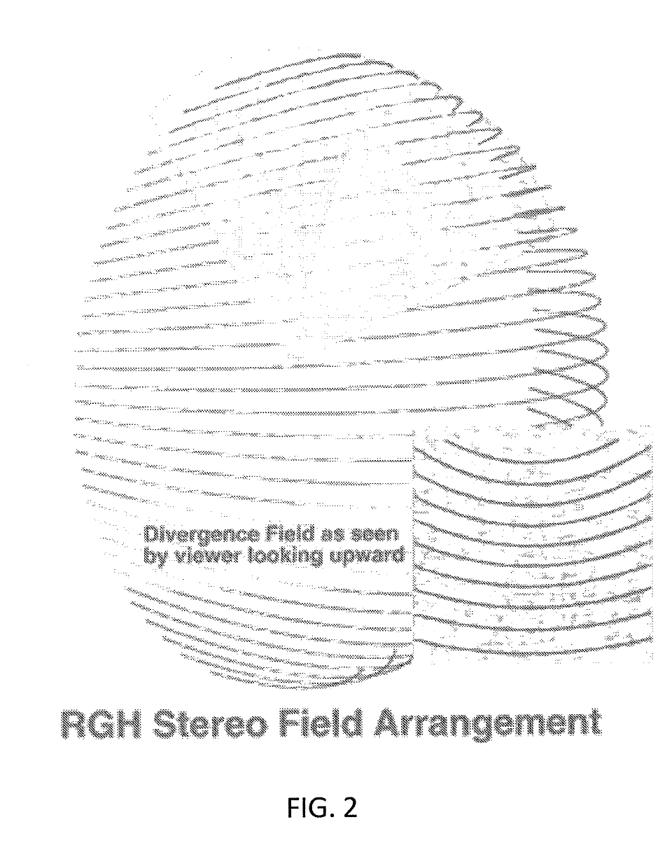

FIG. 2 outlines the following steps of an equidistant stereo lens shader process 100:

Controlling orientation of a stereo field 110;

Controlling orientation of a projection surface relative to a camera 120;

Controlling use of converging stereo rays, or parallel stereo rays 130;

Controlling a zero-parallax distance for converging rays 140;

Controlling an interocular distance 150; and

Outputting left-eye, right-eye, or monoscopic images as equidistant fisheye projections 160.

For clarity, the process for generating the ray origin and direction for a sample of a stereo render that whose stereo orientation sits directly in front of the camera is outlined first:

1. Read image coordinates from render engine

2. Perform equidistant projection, normalize output vector. This is the Primary Ray vector.
a. This is substantially what would be required for a hemispherical image without stereo. This vector is the primary ray direction for this image sample.

3. Perform two more equidistant projections:
a. Vector A=equidistant projection of coordinates with minute increase to u
b. Vector B=equidistant projection of coordinates with minute decrease to u

4. A-B is equivalent to the derivative of the equidistant projection of u, and is the divergence direction.

5. The divergence direction is normalized, and multiplied by one half of the interocular distance. The result is the ray origin for the right eye.

6. The divergence direction is normalized, negated, and multiplied by one half of the interocular distance. The result is the ray origin for the left eye.

7. In the case of a non-converging render, both the left and right eye renders use the same ray direction; this is the Primary Ray vector. Each eye's render uses its own ray origin

8. In the case of a converging render the following happens:
a. The normalized primary ray vector is multiplied by the user zero-parallax distance parameter. This is the convergence point for the current sample.
b. The left eye ray origin is subtracted from the convergence point and normalized. This is the left eye ray direction
c. The right eye ray origin is subtracted from the convergence point and normalized. This is the right eye ray direction.

In the case where a user has altered the dome orientation and/or the stereo field orientation, there are additional steps needed to generate the desired stereo field. These steps deal with the separation of the viewer's primary view direction from the center of the equidistant projection:

1. Read image coordinates from render engine

2. Perform equidistant projection, normalize output vector. This is the Primary Ray vector.
a. This is all that would be required for a hemispherical image without stereo. This vector is the primary ray direction for this image sample.

3. In the case that the dome (projection surface) orientation is something other than [0,0,0]
a. Rotate the Primary Ray vector by the user defined dome orientation

4. Rotate Primary ray vector by the inverse of the user-defined stereo orientation

5. Perform an inverse equidistant projection of the resulting Primary Ray to get new image coordinates

6. Perform two equidistant projections with image coordinates from step 5:
a. Vector A=equidistant projection of coordinates with minute increase to u
b. Vector B=equidistant projection of coordinates with minute decrease to u

7. A-B is equivalent to the derivative of the equidistant projection of u, and is the divergence direction.

8. The divergence direction is normalized, and multiplied by one half of the interocular distance. The result is the ray origin for the right eye.

9. The divergence direction is normalized, negated, and multiplied by one half of the interocular distance. The result is the ray origin for the left eye.

10. In the case of a non-converging render, both the left and right eye renders use the same ray direction; this is the Primary Ray vector. Each eye's render uses its own ray origin

11. In the case of a converging render the following happens:
a. The normalized primary ray vector is multiplied by the user zero-parallax distance parameter. This is the convergence point for the current sample.
b. The left eye ray origin is subtracted from the convergence point and normalized. This is the left eye ray direction
c. The right eye ray origin is subtracted from the convergence point and normalized. This is the right eye ray direction.

Accordingly, equidistant stereo lens shaders and processes are disclosed. While embodiments of this invention have been shown and described, it will be apparent to those skilled in the art that many more modifications are possible without departing from the inventive concepts herein. The invention, therefore, is not to be restricted except in the spirit of the following claims.

1. An equidistant stereo lens shader, comprising:
a user controlled device, including one or more controllers configured for orientation of a stereo field, orientation of a projection surface relative to a camera, use of converging stereo rays or parallel stereo rays, control over the zero-parallax distance for converging rays, and control over the interocular distance; and
an output device that outputs left-eye, right-eye, or monoscopic images as equidistant fisheye projections.

2. An equidistant lens shader process, comprising the steps of:
controlling orientation of a stereo field;
controlling orientation of a projection surface relative to a camera;
controlling use of converging stereo rays, or parallel stereo rays;
controlling a zero-parallax distance for converging rays;
controlling an interocular distance; and
outputting left-eye, right-eye, or monoscopic images as equidistant fisheye projections with the equidistant stereo lens shader of claim 1.
